(19) United States
(12) Patent Application Publication
(10) Pub. No.: US 2016/0104507 A1
(43) Pub. Date: Apr. 14, 2016

(54) Method and Apparatus for Capturing Still Images and Truncated Video Clips from Recorded Video

(71) Applicant: Dustin Pourbaba, Los Angeles, CA (US)

(72) Inventor: Dustin Pourbaba, Los Angeles, CA (US)

(21) Appl. No.: 14/510,345

(22) Filed: Oct. 9, 2014

(51) Int. Cl. G11B 27/00; H04N 5/232; H04N 1/21; H04N 5/77

(52) U.S. Cl. CPC G11B 27/002; H04N 5/772; H04N 5/23216; H04N 5/23293; H04N 1/2125; H04N 5/23245

(57) ABSTRACT

Methods for alternatively capturing one or more still images and/or video clips from a recorded video are provided. In an embodiment, the method comprises accessing a recorded video, displaying the recorded video in a video playback region, and identifying a touch occurring within the video playback region while the recorded video plays. Depending on the duration of the touch identified within the playback area, a still image or video clip may be captured from the playing video. For example, a brief touch—or tap—may capture a still image, while a touch longer than a tap may capture a video clip. In accordance with one or more embodiments, an electronic device comprising one or more controllers is also provided, in which the one or more controllers are configured to perform the functions and operations associated with the above-disclosed methods.

### CROSS-REFERENCE TO RELATED APPLICATIONS

Pursuant to 35 USC 119, this Application claims the right of priority to Provisional Patent Application Ser. No. 61/890,821 filed on Oct. 14, 2013. The content of said application is incorporated herein by reference in its entirety.

### STATEMENT RE. FEDERALLY SPONSORED RESEARCH/DEVELOPMENT

Not applicable.

### NOTICE OF COPYRIGHT AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### TECHNICAL FIELD

The disclosed subject matter relates generally to the production of visual media and, more particularly, to a method and apparatus for extracting high definition, still images and video clips from a recorded video.

### BACKGROUND

There exist electronic devices which employ technology for capturing motion pictures, or videos. These devices allow users to record events as they occur, however, it is often desirable to extract a single image from the videos and even in some cases, a truncated portion of the entire video, commonly called a clip. It is also desirable to share extracted images and/or video clips with others efficiently and independent of a need to electronically transmit any of the large files that are commonly associated with video recordings. Common methods used to achieve these purposes, however, have thus far been cumbersome, time consuming, and imprecise.

One popular method for capturing still images from a video has been to take a screenshot of the video. By way of example, this method may be executed by viewing a video using an Apple iPhone® and then pressing the “home” and “lock” buttons simultaneously as the desired image appears on the screen. This process, and other similar processes employed on smart phone devices, can be problematic though. First, they depend on precise timing to press the appropriate buttons at the exact moment that the desired image appears. Next, such methods often yield low resolution images. Because of this, it can be difficult to enlarge or otherwise reproduce any captured images so that they maintain the same level of clarity as the original source material. A host of additional problems arise when a user attempts to take multiple screen captures using this method.

Problems also arise when the video is recorded on a camera that does not have the screenshooting capabilities. Where this is the case, the video footage must first be uploaded to a computer, where a user can later proceed to view the video on their monitor and take a screenshot there. Other complex software applications have been proposed for achieving similar results as the screenshot but with greater accuracy. These proposals include, for example, applications which use tools to effectively pull out each frame from a recorded video. Using such methods, a user must then view each frame individually until he or she finds the desired image. When such an image is found, the user may finally save it as a single image on the recording device. Such applications often result in the user ending up with much more than they bargained for. Indeed, users of these applications may be left sifting through tens or hundreds of frames from a recorded video all to extract just one or two images from the video.

Likewise, methods and devices for extracting clips from a recorded video have required the use of computer programs and software. As such, the applications are often complex and costly, making them inaccessible to many users.

Thus, a variety of problems still plague prior methods of extracting visual media from recorded videos. Accordingly, there is a need for a simplified method and apparatus for easily and precisely extracting one or more still images and/or video clips from recorded video that avoids the drawbacks of the known methods. There is a further need to do so in a manner that may be utilized across a variety of different platforms and electronic devices.

### SUMMARY

The present disclosure is directed to a method and apparatus that enables users to extract visual media in the form of still images and/or video clips from previously recorded video.

For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

In accordance with one embodiment, a user may access a recorded video through a mobile electronic device, such as a smart phone, using an application stored on the device. Such videos may have been previously recorded and uploaded to the application from a visual media gallery located on the mobile device. In another embodiment, the application may be used directly to record new video.

Once the video is recorded, the user may then proceed to play the video on the mobile electronic device within a playback region of the application. While the application is running and the video is playing on the device, the user may decide to capture a portion of the video that is playing. For example, the user may elect to capture a single image at a point during video playback. The user may alternatively choose to capture a truncated video clip from within the playing video.

At the moment that the user chooses which portion of the playing video he or she would like to extract, the user may proceed to touch the screen within a video playback area. The duration of the user's touch on the screen may instruct the application on whether to extract a still image or clip from the playing video. In one embodiment, for example, a brief tap on the screen may instruct the application to generate a high-resolution photo of the exact image displayed at the time the screen is touched. In another embodiment, a touch that maintains uninterrupted contact with the screen for a period of time may instruct the application to extract a high-definition clip that reflects the exact portion of video displayed over the duration of the uninterrupted contact with the screen. In yet another embodiment, successive brief taps on the screen may instruct the application to extract successive still images from the same recorded video. Similarly, successive touches may instruct the application to extract successive video clips from the same recorded video. Moreover, a combination of brief taps and continuous touches may instruct the application to extract a combination of successive still images and/or video clips from the recorded video.

In one embodiment, the user may be provided with a more simplified and intuitive engagement of the method and apparatus. For example, the settings of the application may be altered so that a brief tap extracts a still image corresponding to a portion of the playing video that appeared slightly before the tap occurred. That is, the portion of the video that a user wishes to capture may have passed by the time the user determines that he or she would like to capture. This feature may adjust for any time delay that occurs when the user discovers an image from the playing video that they would like to create and when they touch the screen. Accordingly, the use of the method and apparatus provided may be made accessible to a larger number of users beyond those who are technologically inclined.

In one embodiment, a user may save images extracted from a playing video directly to any galleries built in to their mobile electronic device. In another embodiment, users may upload extracted images through the Internet to share on existing social media websites such as, for example, Facebook® and Twitter®. In yet another embodiment, a user may choose to upload extracted images to a proprietary social platform designated for use in conjunction with the method and apparatus provided to extract still images from a recorded video.

In accordance with one or more embodiments, a system comprising one or more controllers is provided. The one or more controllers are configured to perform the functions and operations associated with the above-disclosed methods.

It is contemplated that the application settings may also be altered so that a still image and/or video clip is returned for the portion of the recorded video that plays just following the tap or other touch input. Indeed, the settings may even be altered to return a succession of captured images relating to a single tap or touch input. It is even contemplated that the application may be altered so that it returns still images and/or video clips corresponding to the video imagery that plays immediately before and immediately following the user's touch. Where such settings are employed by the application, a user may view successive still images corresponding to the general time period during which he touched the screen. This may allow a user to choose from several still images captured in a similar time period and may further ensure, for example, that blurry or otherwise undesirable captured still images and/or video clips may be discarded. This may also correct a user's imprecise tapping by capturing surrounding imagery.

It is further contemplated that all alternative and additional embodiments discussed may be applied whenever a user intends to capture either or both of still images and video clips from the recorded video. Thus where the application settings may be altered to capture a still image corresponding to earlier shown video imagery, the application settings may be altered to capture a video clip corresponding to earlier shown video imagery. Similarly, where the application settings may be altered to capture a still image corresponding to video imagery that follows the user's touch, the application settings may also be altered to capture a video clip corresponding to video imagery that follows the user's touch.

One or more of the above-disclosed embodiments, in addition to certain alternatives, are provided in further detail below with reference to the attached figures. The disclosed subject matter is not, however, limited to any particular embodiment disclosed.

### DESCRIPTION OF THE DRAWINGS

The disclosed embodiments may be better understood by referring to the figures in the attached drawings, as provided below. The attached figures are provided as non-limiting examples for providing an enabling description of the method and apparatus claimed. Attention is called to the fact, however, that the appended drawings illustrate only typical embodiments of this invention and are therefore not to be considered as limiting of its scope, for the invention may admit to other equally effective embodiments.

### FIGURES

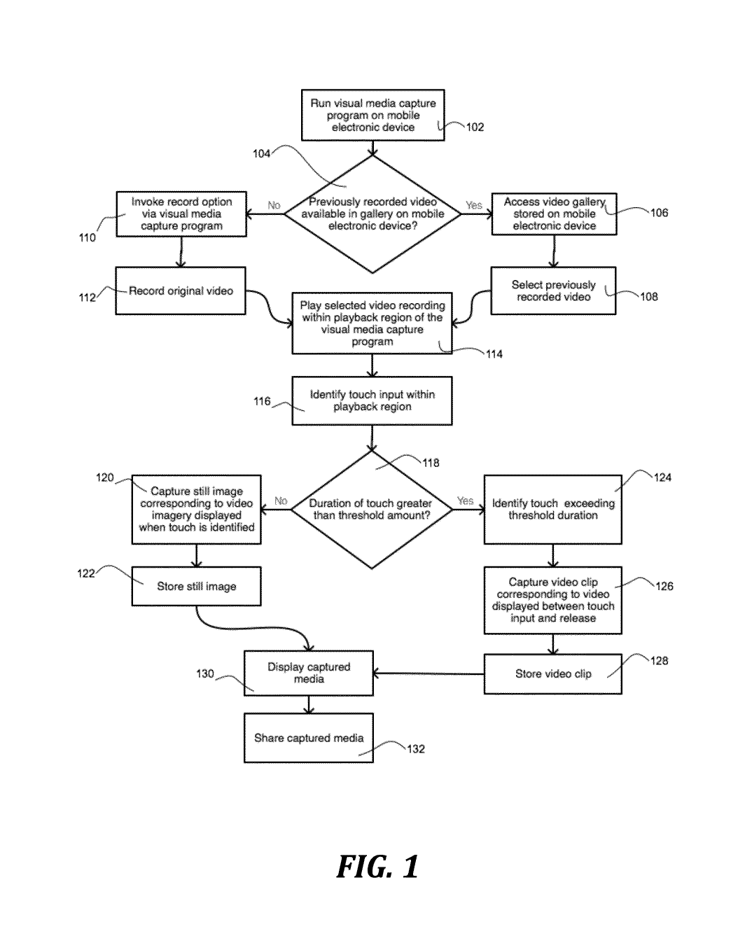

FIG. 1 is a flow diagram illustrating a method of optionally extracting still images and/or clips from a recorded video in an exemplary embodiment of the invention.

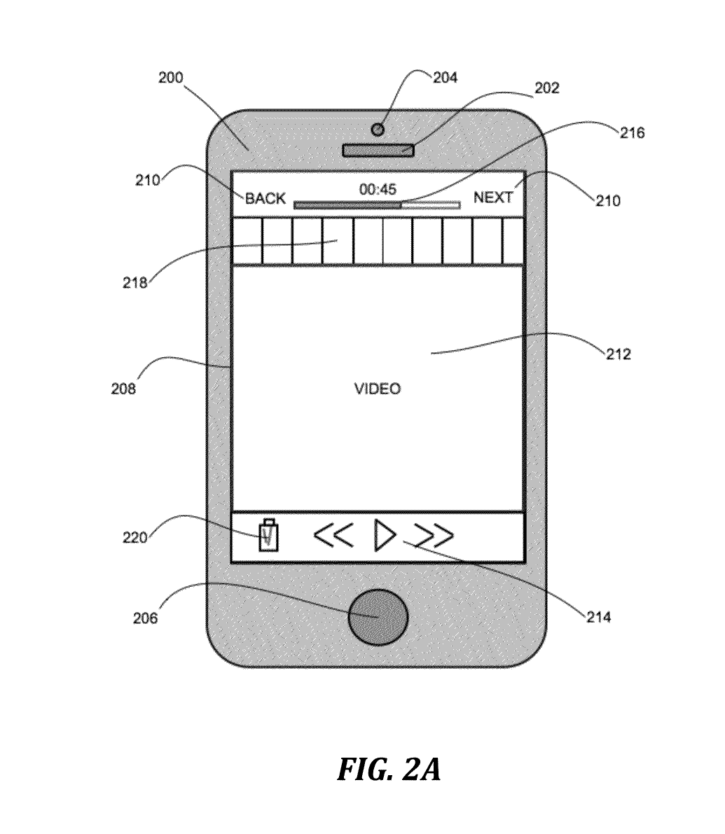

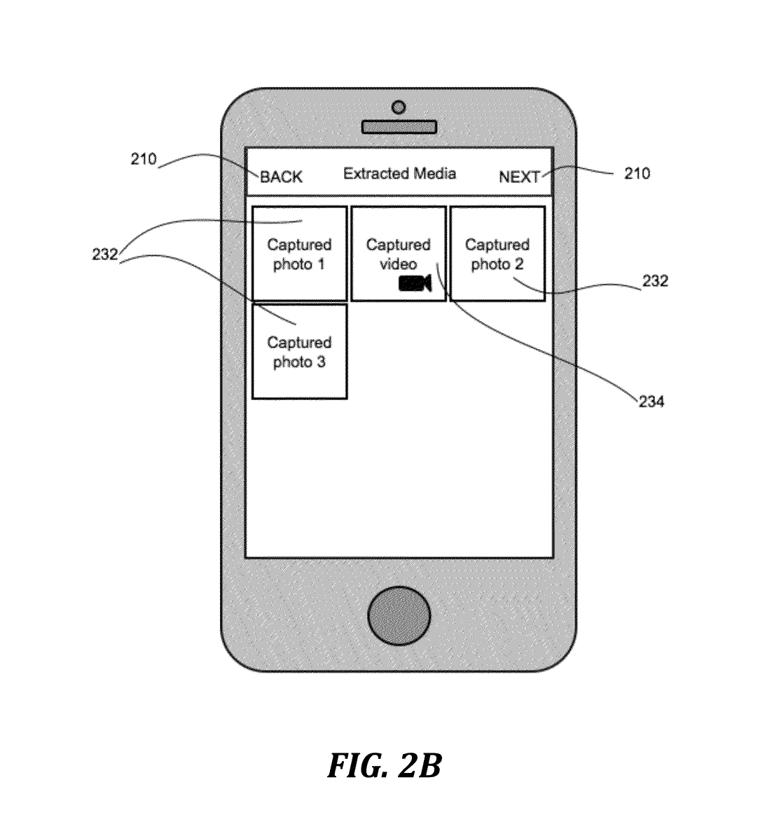

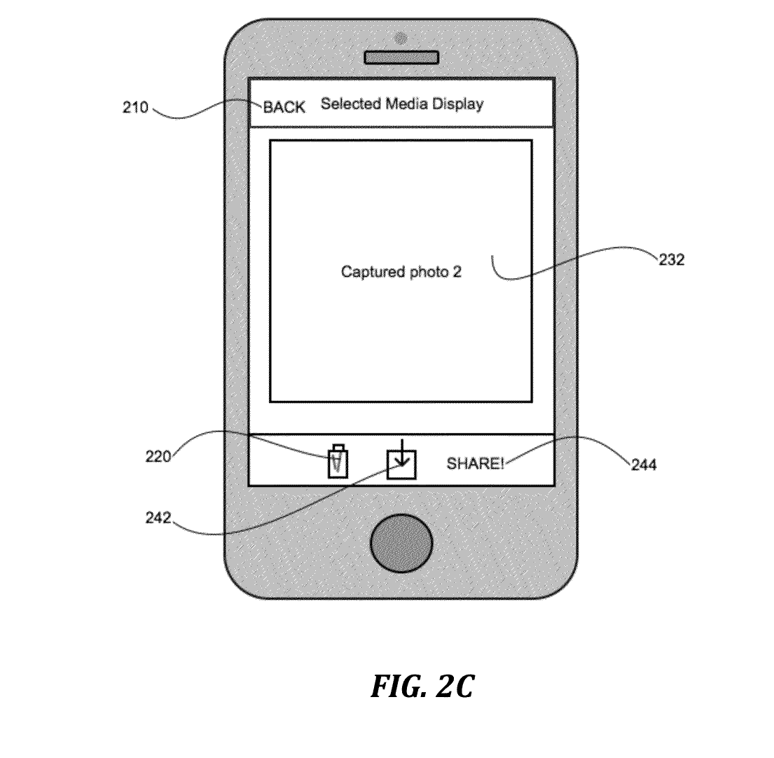

FIGS. 2A-C illustrate the exterior of an apparatus implementing an exemplary method of optionally extracting still images and/or clips from a recorded video.

For simplicity and clarity of illustration, the drawing figures illustrate the general manner of construction, and descriptions of details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. Features, elements, and aspects that are referenced by the same numerals in different figures represent the same, equivalent, or similar features, elements, or aspects, in accordance with one or more embodiments.

In the following, numerous specific details are set forth to provide a thorough description of various embodiments, which provide techniques for optionally capturing still images and video clips from recorded video.

Although described with reference to certain embodiments, it should be understood by those skilled in the art that various changes may be made without departing from the scope of the invention. Indeed, certain embodiments may be achieved without these details or with some variations in detail. It should be understood that the invention is not limited to specific described embodiments. Rather, any combination of the following features, elements, and aspects, whether related to the different embodiments or not, is contemplated to implement and practice the invention, and the detailed description of the drawings, and the drawings themselves, disclose at least one preferred embodiment, and may disclose additional alternative embodiments. Likewise, reference to “the invention” shall not be considered to be an element or limitation of the appended claims except where explicitly recited in a claim(s).

Moreover, some features may be described in less detail so as not to obscure other aspects. The level of detail associated with each of the elements or features should not be construed to qualify the novelty or importance of one feature over the others. In various embodiments, the invention provides numerous advantages over prior art. All elements claimed in any particular claim are essential to the embodiment claimed in that particular claim. Consequently, replacement of one or more claimed elements constitutes reconstruction and not repair. Additionally, although embodiments of the invention may achieve advantages over other possible solutions and/or over the prior art, whether or not a particular advantage is achieved by a given embodiment is not limiting of the invention. Thus, the following features, elements, aspects, embodiments, and advantages are merely illustrative and are not considered elements or limitations of the appended claims except where explicitly recited in a claim(s).

Finally, embodiments and limitations disclosed herein are not dedicated to the public under the doctrine of dedication if the embodiments and/or limitations: (1) are not considered elements or limitations of the appended claims except where explicitly recited in a claim(s), and (2) are or are potentially equivalents of express elements and/or limitations in the claims under the doctrine of equivalents.

### DETAILED DESCRIPTION

FIG. 1 illustrates an embodiment of a method for optionally capturing a still image or video clip from a previously recorded video. In particular, the method may begin by accessing a recorded video 102 using a visual media capture program on a mobile electronic device.

A user may alternatively choose to capture a still image and/or video clip from video that has already been recorded 104. Previously recorded video may be available from many different sources. For example, in one embodiment, a user may access previously recorded video 106 which he or she has stored directly in a gallery on his or her mobile electronic device 200. In another embodiment, it is even contemplated that a user may access previously recorded video 106 which had been previously uploaded to a social media website. In yet another embodiment, a user may access previously recorded video 106 that has been generated using another electronic device, such as a camcorder. Of course, these examples are not intended to limit the method of accessing previously recorded video 106, and are instead provided as exemplary methods of so doing.

From the gallery, the user may then instruct the mobile electronic device to select the previously recorded video 108 so that the program may be further instructed to capture one or more still images and/or video clips from the selected video. Once selected, the video may be played within a video playback region displayed on the screen of the mobile electronic device 114 so that the user may determine which portion of the video he or she would like to capture.

Alternatively, the mobile electronic device may receive instructions from a user to invoke a record option via a visual media capture program 110. If so, the user may record original video using the program 112, rather than choosing from video that had been previously stored in a gallery on the device.

Referring now to FIG. 2A, an exemplary electronic device implementing the methods above is provided. In an embodiment, the mobile electronic device may be a smartphone 200, commonly known in the art. Exemplary smartphones available in the marketplace include, for example, Apple iPhones® using iOS or Google® smartphones operating on Android®. In another embodiment, the method may be implemented using other mobile electronic devices such as a laptop and/or tablet personal computer.

As may be seen, the particular mobile electronic device chosen to implement the foregoing methods may include any standard features of such devices. The pictured smartphone 200, for example, includes an earphone 202, a front-facing camera 204, a home navigation display 206, and touch-sensitive display screen 208. Various embodiments may also includes video on display within a video playback region 212 of the smartphone 200 screen 208.

Many mobile electronic devices, including smartphones, incorporate touch-sensitive screens. These screens allow a user to instruct any computing programs run on the device to follow commands by touching the screens with their finger or other conductive device such as a stylus. In an embodiment, there may be program navigation controls 210 featured in the smartphone-implemented visual media capture program. There may also be video playback controls 214, which allow a user to manipulate the video displayed within the video playback region 212. For example, a user may instruct the program to optionally play, fast-forward, or rewind the video displayed in the playback region 212 by pressing on the screen 208 where icons related to such actions may be located. Similarly, a user may delete 220 a recorded video by pressing on the screen where an icon related to such action is located.

Additional features may be included which might aid the user in choosing one or more portions of the displayed video 212 to capture during playback. For example, a bar and clock indicating time lapse 216 may inform the user how far into the content of the displayed video 212 he or she is. A preview bar 218 which shows a series of frames from the displayed video 212 might also be included. This might allow the user to predict which video imagery will be displayed within the playback region 212 before it is displayed within the video playback region 212 and further allow him to more precisely choose which portion of video to capture.

Returning now to FIG. 1, when the user determines which portion of the playing video he or she would like to capture, he or she may touch the screen within the video playback area. At that time, the visual media capture program may identify any touch input 116 in order to instruct it to capture a portion of the selected video.

The duration of the touch identified by the mobile electronic device may determine whether a still image is captured from the video or whether a truncated portion of the video, also known as a clip, is captured 118. For example, it is contemplated that the visual media capture program may be configured to identify a particular touch on the screen that lasts from about 100 to about 500 milliseconds. That is, the program may identify that about 100 to about 500 milliseconds have passed from the moment that a finger or stylus makes contact with the screen until the finger or stylus is released from the screen. Such a brief touch may be commonly recognized as a natural tapping gesture and may moreover define a threshold duration that determines that a still image, rather than a clip, will be captured. Thus, in one embodiment, when the program identifies a touch lasting for less than about 500 milliseconds, the program may identify a tap and be instructed to capture a still image 120 that corresponds to the video imagery displayed at the time of the touch.

In another embodiment, the program may be configured to identify a touch that exceeds the threshold duration 124. Thus, when a touch lasts for longer than about 500 milliseconds, the visual media capture program may be instructed to capture the video that elapsed in between contact engagement and contact release within the video play back region 126.

In one embodiment, the identification of touch duration and resulting capture of a portion of the recorded video may occur while the video is playing. The video need not pause in order to capture the desired portions. Indeed, it may even capture the desired portion instantaneously so that the video continues to play through any tapping gesture that is identified within the video playback region. As a result, the program may be configured to identify successive touches that might occur within the playback region.

The visual media capture program may also be configured to store any alternatively captured still images or video clips 120, 128 for future review by a user. Thus, as may be seen in FIG. 2B, the exemplary smartphone-implemented method for capturing still images and/or video clips may include a page that stores each of the captured portions of the recorded video. In particular, it may be seen that a combination of still images 232 and video clips 234 may be stored together. Such storage may be also navigable by pressing the application navigation controls 210. This particular feature may allow a user to return to the recorded video to capture additional still images and/or video clips. Alternatively, it may allow the user to proceed with additional steps in the disclosed methods.

Once any desired portions of the recorded video are captured and stored, the visual media capture program may display the captured media 130 on the screen of the mobile electronic device for review, as in FIG. 1. This is further illustrated in FIG. 2C, wherein a chosen still image 232 appears enlarged within the smartphone display screen. From this display, a user may decide to discard captured media by pressing a related icon 220. or even to share captured media 132 outside of the visual media capture program. In one embodiment, for example, the program may be instructed to share one or more of the captured media by saving it to a gallery built in to the mobile electronic device. This may be achieved by pressing a related icon 242. In an embodiment, the program may be instructed to share images by uploading them through the Internet on to social media websites. Such websites may include, for example, Facebook® and Twitter®. This may be achieved by pressing its own related icon 244. In yet another embodiment, the program may be instructed to upload extracted images to a proprietary social platform designated for use in conjunction with the present methods and devices provided to capture still images from a recorded video.

In one embodiment, the invention may be implemented by a program product for use with a computer system. The program(s) of the program product may define functions of the embodiments (including the methods described herein) and can be contained on a variety of computer readable storage media. For the purposes of this description, a computer-readable medium can be any apparatus that can contain, store, communicate, propagate or transport the program for use by or in connection with the instruction execution system, apparatus or device.

Illustrative computer-readable media may be an electronic, magnetic, optical, electromagnetic, infrared, or semiconductor system (or apparatus or device) or a propagation medium. Examples of such computer-readable media include but are not limited to: (i) non-writable storage media on which information is permanently stored, for example, read-only memory devices within a computer, such as CD-ROM disks readable by CD-ROM drive; (ii) writable storage media on which alterable information is stored, for example, floppy disks within a diskette drive or hard-disk drive. Such computer-readable instructs that direct the functions of the present invention are embodiments of the present invention.

Other media may include communications media through which information is conveyed to a computer, such as through a computer or telephone network, including wireless communications networks. Such wireless communications networks may specifically include the transmission of information to and/or from the Internet and other networks. Such communications media, when carrying computer-readable instructions directing the functions of the invention are embodiments of the invention. Thus, broadly, computer-readable storage media and communications media may be referred herein as computer-readable media.

In general, the routines executed to implement the embodiments of the invention may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

The mobile electronic devices disclosed herein may be a tablet computer or smartphone but may also be embodied in any one of a wide variety of wired and/or wireless computing devices. The mobile device includes a processing device (processor), input/output interfaces, a display, a touchscreen interface, a network interface, a memory, and operating system, a mass storage and a global positioning system (GPS), with each communicating across a local data bus. Additionally, the mobile device incorporates a method for capturing still images from recorded video

The processing device may include any custom made or commercially available processor, a central processing unit (CPU) or an auxiliary processor among several processors associated with the mobile device, a semiconductor based microprocessor (in the form of a microchip), a macroprocessor, one or more application specific integrated circuits (ASICs), a plurality of suitably configured digital logic gates, and other electrical configurations comprising discrete elements both individually and in various combinations to coordinate the overall operation of the system.

The memory can include any one of a combination of volatile memory elements (e.g., random-access memory (RAM, such as DRAM, and SRAM, etc.)) and nonvolatile memory elements. The memory typically comprises a native operating system, one or more native applications, emulation systems, or emulated applications for any of a variety of operating systems and/or emulated hardware platforms, emulated operating systems, etc. For example, the applications may include application specific software which may comprise some or all the components of the mobile device. In accordance with such embodiments, the components are stored in memory and executed by the processing device. Note that the method for capturing still images from recorded video may be resident in such memory.

Touchscreen interface is configured to detect contact within the display area of the display and provides such functionality as on-screen buttons, menus, keyboards, etc. that allows users to navigate user interfaces by touch. For some embodiments, the mobile device will comprise GPS or other means to determine the location of the mobile device.

While certain embodiments of the invention have been illustrated and described, various modifications are contemplated and can be made without departing from the spirit and scope of the invention. For example, the touch input used to extract visual media from a recorded video is described as a single finger touch on the touch-sensitive screen of the mobile electronic device in some embodiments even though the possibility of various other gestures is contemplated and within the scope of the appended claim(s). For example, multi-finger gestures may also be employed to instruct the extraction of still images or video clips, all the while comprising the properties of the invention. Accordingly, it is intended that the invention not be limited, except as by the appended claim(s).

The teachings disclosed herein may be applied to other systems, and may not necessarily be limited to the system described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the method and apparatus for capturing still images from recorded video with which that terminology is associated. In general, the terms used in the following claims should not be constructed to limit the method and apparatus for capturing still images from recorded video to the specific embodiments disclosed in the specification unless the above description section explicitly defines such terms. Accordingly, the actual scope encompasses not only the disclosed embodiments, but also all equivalent ways of practicing or implementing the disclosed method and apparatus. The above description of embodiments of the method and apparatus for capturing still images from recorded video is not intended to be exhaustive or limited to the precise form disclosed above or to a particular field of usage. While specific embodiments of, and examples for, the method and apparatus are described above for illustrative purposes, various equivalent modifications are possible for which those skilled in the relevant art will recognize.

While certain aspects of the method and apparatus disclosed are presented below in particular claim forms, various aspects of the method and apparatus are contemplated in any number of claim forms. Thus, the inventor reserves the right to add additional claims after filing the application to pursue such additional claim forms for other aspects of the method and apparatus for capturing still images and truncated video clips from recorded video.

What is claimed is:

1. A method for alternatively capturing a still image or video clip from recorded video for execution on a mobile electronic device, the method comprising:
accessing a recorded video;
displaying the recorded video within a video playback region;
identifying a touch occurring within the video playback region while the recorded video plays; and
alternatively capturing a still image or video clip that corresponds to any video imagery displayed within the video playback region at the time the touch occurs, wherein the duration of the touch determines whether to extract a still image or video clip from the recorded video.

2. The method of claim 1, wherein the accessing step comprises selecting previously recorded video media stored on the mobile electronic device itself to play within the video playback region.

3. The method of claim 1, wherein the accessing step comprises the additional steps of invoking a record option via a computer implemented video capture program, and immediately playing back any resulting video recording within the video playback region.

4. The method of claim 1, further comprising the step of selectively saving any alternatively captured still images or video clips to a gallery stored on the mobile electronic device.

5. The method of claim 1, further comprising the step of selectively sharing any alternatively captured still images or video clips.

6. The method of claim 1, wherein a still image is captured upon a determination that the touch duration is less than about 500 milliseconds.

7. The method of claim 1, wherein a video clip is captured upon a determination that the touch duration lasts at least about 500 milliseconds.

8. An electronic device, comprising:
a touch sensitive display defining a video playback region, the video playback region presenting a previously recorded video on command;
a touch controller to identify a touch, and evaluate the duration of the touches; and
a media capture controller;
wherein and the media capture controller is instructed to capture a still image and/or video clip when the touches occur within the video playback region, the media capture controller is further instructed to capture the still image or video clip depending on an evaluation of the duration of the touch.

9. The electronic device of claim 8, wherein the media capture controller is instructed to capture a still image when the touch controller identifies and evaluates a touch duration of less than about 500 milliseconds, said touch duration defining a tap.

10. The electronic device of claim 8, wherein the media capture controller is instructed to capture a video clip when the touch controller identifies and evaluates a prolonged touch duration lasting longer than about 500 milliseconds, said prolonged touch duration defining a long touch.

11. The electronic device of claim 8, wherein any video imagery presented in the video playback region at the time that the touch controller identifies a touch defines the alternatively captured still images or video clips.

12. The electronic device of claim 8, wherein the touch controller is capable of identifying a plurality of successive touches during video playback, the plurality of successive touches comprising a combination of taps and/or long touches; and wherein the media capture controller is instructed to respectively extract still images and/or video clips depending on the touch controller's evaluation of the duration of each of the plurality of successive touches.

13. The electronic device of claim 8, wherein the resolution of any video imagery presented within the video playback region is preserved in captured still image or video clip.

14. The electronic device of claim 8, further comprising one or more digital image sensors to capture original video content.

15. A method for extracting a still image from recorded video for execution on a mobile electronic device, the method comprising:
accessing a recorded video;
displaying the accessed video within a video playback region;
identifying a touch occurring within the video playback region while the accessed video plays; and
capturing a still image corresponding to any video imagery displayed within the video playback region at the time the touch is identified.
